(19) United States
(12) Patent Application Publication
(10) Pub. No.: US 2016/0347951 A1
(43) Pub. Date: Dec. 1, 2016

(54) THERMOPLASTIC COMPOSITION AND ARTICLE

(71) Applicant: SABIC GLOBAL TECHNOLOGIES B.V., Bergen op Zoom (NL)

(72) Inventors: Huihui Wang, Shanghai (CN); Bing Guan, Shanghai (CN); Huihui Li, Shanghai (CN)

(21) Appl. No.: 15/117,262

(22) PCT Filed: Feb. 12, 2015
(86) PCT No.: PCT/IB2015/051065

§ 371 Date: Aug. 8, 2016

Related U.S. Application Data
(63) Continuation of application No. 14/185,073, filed on Feb. 20, 2014, now abandoned.

(51) Int. Cl. C08L 69/00

(52) U.S. Cl. CPC C08L 69/00; C08L 2207/04; C08L 2201/02; C08L 2205/025; C08L 2205/03; C08L 2205/035

(57) ABSTRACT

A black-colored plastic composition includes specific amounts of a brominated polycarbonate, a poly(butylene terephthalate), a block polyestercarbonate containing resorcinol ester units, diantimony trioxide, and a black colorant. The composition exhibits a deeper black color than a corresponding composition without the block polyestercarbonate. The composition can be used to mold black parts of consumer electronic devices, such as flat screen television bezels, cell phone backs, and exterior parts of household appliances such as toasters and microwave ovens.

### BACKGROUND OF THE INVENTION

Black-colored plastics are commonly used for consumer electronics parts, including flat screen television bezels and mobile phone backs. Deep black polycarbonate compositions can be prepared, but with use they can exhibit environmental stress cracking due to inadequate chemical resistant. Blends of polycarbonate and poly(butylene terephthalate) exhibit improved chemical resistance, but the addition to these blends of common additives, including impact modifiers, fillers, and flame retardants, can cause yellowing and reduce the optical clarity of the blends. There remains a need for black-colored plastics capable of exhibiting an improved balance of deep black color, flame retardancy, and impact strength.

### BRIEF SUMMARY OF EMBODIMENTS OF THE INVENTION

One embodiment is a composition comprising, based on the total weight of the composition: 20 to 50 weight percent of a brominated polycarbonate; 10 to 50 weight percent of poly(butylene terephthalate); 10 to 40 weight percent of a block polyestercarbonate comprising a polyester block comprising resorcinol ester repeat units having the structure

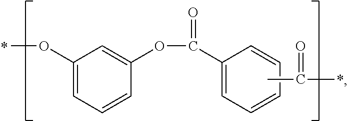

and a polycarbonate block comprising carbonate repeat units having the structure

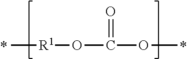

wherein at least 60 percent of the total number of R¹ groups are aromatic; 2 to 10 weight percent of diantimony trioxide; and 0.2 to 5 weight percent of a black colorant.

Another embodiment is an article comprising a composition comprising, based on the total weight of the composition: 20 to 50 weight percent of a brominated polycarbonate; 10 to 50 weight percent of poly(butylene terephthalate); 10 to 40 weight percent of a block polyestercarbonate comprising a polyester block comprising resorcinol ester repeat units having the structure

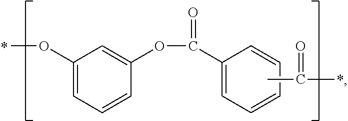

and a polycarbonate block comprising carbonate repeat units having the structure

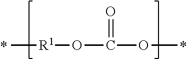

wherein at least 60 percent of the total number of R¹ groups are aromatic; 2 to 10 weight percent of diantimony trioxide; and 0.2 to 5 weight percent of a black colorant.

These and other embodiments are described in detail below.

### BRIEF DESCRIPTION OF THE DRAWINGS

FIG. 1 is a photographic image of eight color chips, chips 1-8 corresponding, respectively, to Comparative Examples 1 and 2, Examples 1 and 2, Comparative Examples 3 and 4, and Examples 3 and 4.

FIG. 2 consists of eight scanning electron micrographs of surface portions of molded samples, with images (a) to (h) corresponding, respectively, to Comparative Examples 1 and 2, Examples 1 and 2, Comparative Examples 3 and 4, and Examples 3 and 4.

FIG. 3 consists of three scanning electron micrographs of surface portions of molded samples, with images (a) to (c) corresponding, respectively, to Comparative Example 5, Example 10, and Example 7.

### DETAILED DESCRIPTION OF THE INVENTION

The present inventors have determined that certain black-colored blends of brominated polycarbonate, poly(butylene terephthalate), a particular polyestercarbonate, and diantimony trioxide provide an improved balance of deep black color, flame retardancy, and impact strength relative to corresponding blends without the polyestercarbonate.

Thus, one embodiment is a composition comprising, based on the total weight of the composition: 20 to 50 weight percent of a brominated polycarbonate; 10 to 50 weight percent of poly(butylene terephthalate); 10 to 40 weight percent of a block polyestercarbonate comprising a polyester block comprising resorcinol ester repeat units having the structure

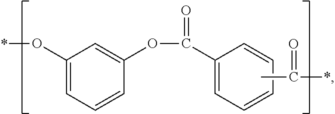

and a polycarbonate block comprising carbonate repeat units having the structure

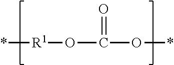

wherein at least 60 percent of the total number of R¹ groups are aromatic; 2 to 10 weight percent of diantimony trioxide; and 0.2 to 5 weight percent of a black colorant.

The composition comprises a brominated polycarbonate. The brominated polycarbonate can have a weight average molecular weight (Mw) of 8,000 to more than 200,000 atomic mass units, specifically of 20,000 to 80,000 atomic mass units, and an intrinsic viscosity of 0.30 to 1.0 deciliter/gram as measured in methylene chloride at 25° C. The brominated polycarbonate can be branched or unbranched.

In some embodiments, the brominated polycarbonate is the polymerization product of a brominated dihydric phenol and a carbonate precursor. Alternatively, the brominated polycarbonate can be the polymerization product of a carbonate precursor and a mixture of brominated and non-brominated aromatic dihydric phenols. Flame retardant brominated polycarbonates are disclosed, for example, in U.S. Pat. No. 3,929,908 to Orlando et al., U.S. Pat. No. 4,170,711 to Lavallee et al., and U.S. Pat. No. 4,923,933 to Curry.

Exemplary brominated dihydric phenols include 2,2-bis(3,5-dibromo-4-hydroxyphenyl)propane and 2,2′,6,6′-tetramethyl-3,3′,5,5′-tetrabromo-4,4′-biphenol. Exemplary non-brominated dihydric phenols for mixing with brominated dihydric phenols to produce brominated polycarbonates can include, for example, 2,2-bis(4-hydroxyphenyl)propane, bis(4-hydroxyphenyl)methane, 2,2-bis(4-hydroxy-3-methylphenyl)propane, 4,4-bis(4-hydroxyphenyl)heptane, and (3,3′-dichloro-4,4′-dihydroxydiphenyl)methane. Mixtures of two or more different brominated and non-brominated dihydric phenols can be used. Branched brominated polycarbonates can also be used, as can blends of a linear brominated polycarbonate and a branched brominated polycarbonate.

The carbonate precursor can be a carbonyl halide, such as phosgene, or a carbonate ester, such as dimethyl carbonate or diphenyl carbonate.

In some embodiments, the brominated polycarbonate comprises 15 to 50 weight percent bromine, based on the weight of the brominated polycarbonate. Within this range, the weight percent bromine can be 20 to 40 weight percent, specifically 25 to 35 weight percent.

Synthesis of the brominated polycarbonate can utilize a monohydric phenol, which limits molecular weight and endcaps the polycarbonate. Suitable monohydric phenols include phenol, 4-(1,1,3,3-tetramethylbutyl)phenol, para-tertiary-butylphenol, 4-cumylphenol, and mixtures thereof.

In some embodiments, the brominated polycarbonate comprises repeat units having the structures

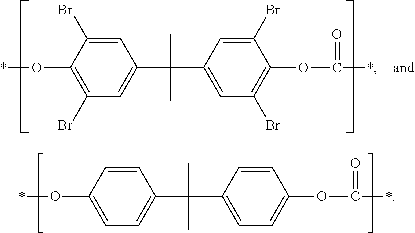

The composition comprises the brominated polycarbonate in an amount of 20 to 50 weight percent, based on the total weight of the composition. Within this range, the brominated polycarbonate amount can be 25 to 45 weight percent, specifically 28 to 38 weight percent. In some embodiments, the composition comprises 7 to 17 weight percent total bromine.

In addition to the brominated polycarbonate, the composition comprises poly(butylene terephthalate), CAS Registry No. 26062-94-2. In some embodiments, the poly(butylene terephthalate) has an intrinsic viscosity of 0.5 to 2 deciliter/gram, measured at 25° C. in chloroform. Within this range, the intrinsic viscosity can be 0.7 to 1.5 deciliter/gram, specifically 0.8 to 1.4 deciliter per gram.

The composition comprises the poly(butylene terephthalate) in an amount of 10 to 50 weight percent, based on the total weight of the composition. Within this range, the poly(butylene terephthalate) amount can be 15 to 45 weight percent, specifically 15 to 35 weight percent, more specifically 15 to 25 weight percent.

In addition to the brominated polycarbonate and the poly(butylene terephthalate), the composition comprises a block polyestercarbonate. The block polyestercarbonate comprises a polyester block comprising resorcinol ester repeat units having the structure

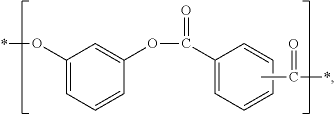

and
a polycarbonate block comprising carbonate repeat units having the structure

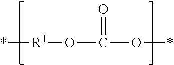

wherein at least 60 percent of the total number of R¹ groups are aromatic. It will be understood that the block polyestercarbonate can include more than one polyester block and/or more than one polycarbonate block. In other words, the block polyestercarbonate can be a diblock, triblock, or multiblock copolymer.

In some embodiments, R¹ can be derived from a dihydroxy compound such as an aromatic dihydroxy compound having the structure

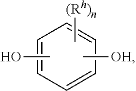

wherein n is 0, 1, 2, 3, or 4, and each R¹ is independently a halogen atom (for example bromine), a C₁₋₁₀ alkyl, a halogen-substituted C₁₋₁₀ alkyl, a C₆₋₁₀ aryl, or a halogen-substituted C₆₋₁₀ aryl; or a bisphenol having the structure

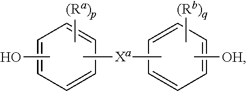

wherein p and q are each independently 0, 1, 2, 3, or 4, such that when p or q is less than 4, the valence of each carbon of the ring is filled by hydrogen, and R^{a} and R^{b} are each independently a halogen, C₁₋₁₂ alkoxy, or C₁₋₁₂ alkyl, and X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. The bridging group X^{a} can be, for example, a single bond, —O—, —S—, —S(O)—, —S(O)₂—, —C(O)—, or a divalent C₁₋₁₈ organic group, which can be cyclic or acyclic, aromatic or non-aromatic, and can further comprise heteroatoms such as halogens, oxygen, nitrogen, sulfur, silicon, or phosphorus. For example, X^{a} can be a substituted or unsubstituted C₃₋₁₈ cycloalkylidene; a C₁₋₂₅ alkylidene of the formula —C(R^{c})(R^{d})— wherein R^{e} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Examples of specific dihydroxy compounds and bisphenol compounds such include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol compounds such as resorcinol, 5-methylresorcinol, 5-ethylresorcinol, 5-propylresorcinol, 5-butylresorcinol, 5-t-butylresorcinol, 5-phenylresorcinol, 5-cumylresorcinol, 2,4,5,6-tetrafluoro resorcinol, and 2,4,5,6-tetrabromo resorcinol; catechol; hydroquinone, 2-methylhydroquinone, 2-ethylhydroquinone, 2-propylhydroquinone, 2-butylhydroquinone, 2-t-butylhydroquinone, 2-phenylhydroquinone, 2-cumylhydroquinone, 2,3,5,6-tetramethylhydroquinone, 2,3,5,6-tetra-t-butylhydroquinone, 2,3,5,6-tetrafluorohydroquinone, 2,3,5,6-tetrabromohydroquinone; and combinations thereof.

Specific dihydroxy compounds include resorcinol, 2,2-bis(4-hydroxyphenyl) propane (“bisphenol A”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP” or 3,3-bis(4-hydroxyphenyl)-2-phenylisoindolin-1-one), 1,1-bis(4-hydroxy-3-methylphenyl)cyclohexane (DMBPC), 1,1-bis(4-hydroxy-3-methylphenyl)-3,3,5-trimethylcyclohexane, and mixtures thereof.

In some embodiments of the block polyestercarbonate, the polycarbonate block comprises carbonate repeat units having the structure

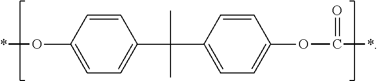

In some embodiments of the block polyestercarbonate, the polyester block comprises resorcinol ester repeat units having the structures

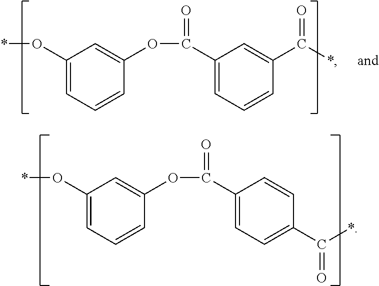

These resorcinol isophthalate and resorcinol terephthalate units, respectively, can be present in a mole ratio of 10:90 to 90:10, specifically 30:70 to 70:30, more specifically 45:55 to 55:45.

In some embodiments, the block polyestercarbonate further comprises resorcinol carbonate repeat units having the structure

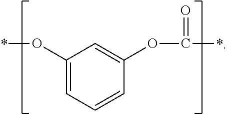

Such a repeat unit constitutes a linkage between a polyester block and a polycarbonate block.

Methods of forming block polyestercarbonates are known and include, for example, U.S. Pat. No. 6,306,507 to Brunelle et al., U.S. Pat. No. 6,559,270 to Siclovan et al., U.S. Pat. No. 6,812,320 to Silva et al., U.S. Pat. No. 7,078,447 to Glasgow et al., U.S. Pat. No. 7,109,274 to Acar et al., and 7,686,997 to Agarwal et al. In a representative procedure, hydroxyl-terminated polyester blocks are formed by reaction of excess resorcinol with a mixture of isophthaloyl chloride and terephthaloyl chloride in methylene chloride in the presence of base. Without isolating the hydroxyl-terminated polyester blocks, bisphenol A and a small amount of phenol are added to the reaction mixture with water (to dissolve salts) and additional methylene chloride. Phosgene and sodium hydroxide are then gradually added to the reaction mixture, producing the phenol-capped block polyestercarbonate, which is isolated by precipitation in a mixture of hot water and methylene chloride.

The block polyestercarbonate can comprise 5 to 95 weight percent of the polyester block, and 95 to 5 weight percent of the polycarbonate block. Within this range, the weight ratio of polyester block to polycarbonate block can be 10:90 to 90:10, specifically 20:80 to 80:20. Particularly useful block polyestercarbonates comprise 10 to 40 weight percent of the polyester block and 60 to 90 weight percent of the polycarbonate block, specifically 10 to 30 weight percent of the polyester block and 90 to 70 weight percent of the polycarbonate block.

The composition comprises the block polyestercarbonate in an amount of 10 to 40 weight percent, based on the total weight of the composition. Within this range, the block polyestercarbonate amount can be 15 to 40 weight percent, specifically 25 to 35 weight percent.

The composition further comprises diantimony trioxide (Sb₂O₃; CAS Registry No. 1309-64-4). In some embodiments, the diantimony trioxide is provided in the form of a mixture containing 70 to 90 weight percent diantimony trioxide and 10 to 30 weight percent poly(ethylene-co-vinyl acetate), based on the weight of the mixture.

The composition comprises diantimony trioxide in an amount of 2 to 10 weight percent, based on the total weight of the composition. Within this range, the diantimony trioxide amount can be 4 to 8 weight percent.

The composition comprises a black colorant. Suitable black colorants include dyes, pigments, and mixtures thereof. In some embodiments, the black colorant comprises carbon black. Suitable carbon blacks are commercially available and include, for example, MONARCH™ 800, MONARCH™ 900, MONARCH™ 1000, and MONARCH™ 1400 from Cabot; SATIN BLACK™ SBX452, SATIN BLACK™ SBX552, and SATIN BLACK™ SBX652 from Continental Carbon; RAVEN™ 2500 from Columbian Chemicals; and PRINTEX™ 85 from Degussa. In some embodiments, the black colorant comprises at least two organic dyes. Suitable dye classes from which the at least two organic dyes can be selected include anthraquinones, anthrapyridones, perylenes, anthracenes, perinones, indanthrones, quinacridones, xanthenes, thioxanthenes, oxazines, oxazolines, indigoids, thioindigoids, quinophthalones, naphthalimides, cyanines, methines, pyrazolones, lactones, coumarins, bis-benzoxazolylthiophenes, naphthalenetetracarboxylic acids, phthalocyanines, triarylmethanes, aminoketones, bis(styryl)biphenyls, azines, rhodamines, derivatives of the foregoing, and combinations thereof. Specific organic dyes suitable for use among the at least two organic dyes include Disperse Yellow 201, Solvent Green 3, Solvent Red 52, Solvent Red 135, Solvent Violet 13, Disperse Orange 47, Solvent Orange 60, and Solvent Blue 104. When the colorant includes organic dyes and particularly when the colorant consists of organic dyes, at least two dyes of different colors can be employed to produce a black color. For example, black color can be provided by a combination of a red and green dye, or a combination of a blue dye and an orange dye, or a combination of a purple dye and a yellow dye. In some embodiments, the black colorant comprises carbon black, at least two dyes, or a combination thereof.

The composition comprises the black colorant in an amount of 0.2 to 5 weight percent, based on the total weight of the composition. Within this range, the black colorant amount can be 0.4 to 2 weight percent, specifically 0.4 to 1.5 weight percent.

In some embodiments, the composition further comprises an impact modifier. Suitable impact modifiers include poly(butyl acrylate-co-methyl methacrylate), poly(acrylonitrile-co-butadiene-co-styrene) (including high rubber graft poly(acrylonitrile-co-butadiene-co-styrene)), poly(methyl methacrylate-co-butadiene-co-styrene), poly(acrylonitrile-co-styrene-co-acrylate), polyolefin elastomer, polycarbonate-polysiloxane block copolymer, and combinations thereof. In some embodiments, the impact modifier comprises poly(butyl acrylate-co-methyl methacrylate). When present, the impact modifier can be used in an amount of 4 to 14 weight percent, based on the total weight of the composition. Within this range, the impact modifier amount can be 5 to 11 weight percent, specifically 6 to 9 weight percent.

In some embodiments, the composition further comprises an unbrominated polycarbonate. Unbrominated polycarbonates can comprise repeat units having the structure

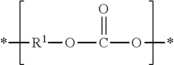

wherein at least 60 percent of the total number of R² groups are aromatic, and all of the R² groups are bromine-free.

The group R² can be derived from a dihydroxy compound or a bisphenol compound. Examples of such compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol compounds such as resorcinol, 5-methylresorcinol, 5-ethylresorcinol, 5-propylresorcinol, 5-butylresorcinol, 5-t-butylresorcinol, 5-phenylresorcinol, 5-cumylresorcinol, and 2,4,5,6-tetrafluororesorcinol; catechol; hydroquinone, 2-methylhydroquinone, 2-ethylhydroquinone, 2-propylhydroquinone, 2-butylhydroquinone, 2-t-butylhydroquinone, 2-phenylhydroquinone, 2-cumylhydroquinone, 2,3,5,6-tetramethylhydroquinone, 2,3,5,6-tetra-t-butylhydroquinone, 2,3,5,6-tetrafluorohydroquinone; and combinations thereof.

Specific dihydroxy compounds useful for forming the unbrominated polycarbonate include resorcinol, 2,2-bis(4-hydroxyphenyl) propane (“bisphenol A”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP” or 3,3-bis(4-hydroxyphenyl)-2-phenylisoindolin-1-one), 1,1-bis(4-hydroxy-3-methylphenyl)cyclohexane (DMBPC), 1,1-bis(4-hydroxy-3-methylphenyl)-3,3,5-trimethylcyclohexane, and mixtures thereof.

In some embodiments of the block polyestercarbonate, the polycarbonate block comprises carbonate repeat units having the structure

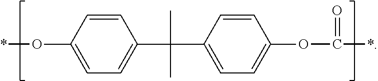

When present, the unbrominated polycarbonate can be used in an amount of 5 to 20 weight percent, based on the total weight of the composition. Within this range, the unbrominated polycarbonate amount can be 7 to 16 weight percent.

The composition can, optionally, further comprise one or more additives, including flow modifiers, fillers (including fibrous and scale-like fillers), antioxidants, heat stabilizers, light stabilizers, ultraviolet (UV) light stabilizers, UV absorbing additives, plasticizers, lubricants, mold release agents, antistatic agents, anti-fog agents, antimicrobial agents, surface effect additives, radiation stabilizers, flame retardants, anti-drip agents (e.g., a PTFE-encapsulated styrene-acrylonitrile copolymer (TSAN)), and combinations thereof. In general, the additives, when present, are used in a total amount of less than or equal to 5 weight percent, based on the total weight of the composition. Within this limit, the additives can be used in a total amount of less than or equal to 2 weight percent, specifically less than or equal to 1.5 weight percent.

In a very specific embodiment of the composition, the polyester block comprises resorcinol ester repeat units having the structures

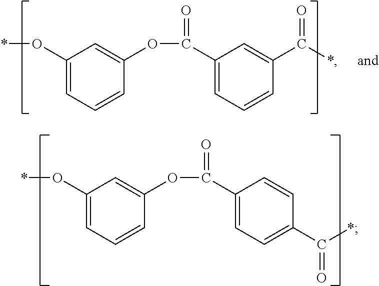

the polycarbonate block comprises carbonate repeat units having the structure

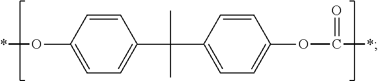

the block polyestercarbonate comprises 10 to 40 weight percent of the polyester block and 60 to 90 weight percent of the polycarbonate block; the brominated polycarbonate comprises repeat units having the structures

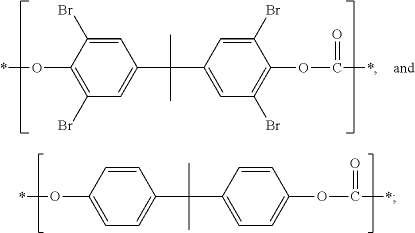

the black colorant comprises carbon black; the composition comprises 28 to 38 weight percent of the brominated polycarbonate, 10 to 25 weight percent of the poly(butylene terephthalate), 25 to 35 weight percent of the block polyestercarbonate, 4 to 8 weight percent of the diantimony trioxide, and 0.4 to 2 weight percent of the black colorant; and the composition further comprises 5 to 11 weight percent of a poly(butyl acrylate-co-methyl methacrylate).

Another embodiment is an article comprising a composition comprising, based on the total weight of the composition: 20 to 50 weight percent of a brominated polycarbonate; 10 to 50 weight percent of poly(butylene terephthalate); 10 to 40 weight percent of a block polyestercarbonate comprising a polyester block comprising resorcinol ester repeat units having the structure

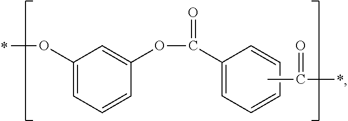

and a polycarbonate block comprising carbonate repeat units having the structure

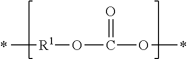

wherein at least 60 percent of the total number of R¹ groups are aromatic; 2 to 10 weight percent of diantimony trioxide; and 0.2 to 5 weight percent of a black colorant. All of the above-described variations of the composition apply as well to the composition used to form the article.

The composition is particularly suitable for molding flat screen television bezels, cell phone backs, and exterior parts of household appliances such as toasters and microwave ovens.

In a very specific embodiment of the article, the polyester block comprises resorcinol ester repeat units having the structures

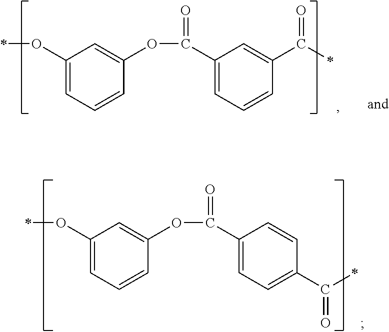

the polycarbonate block comprises carbonate repeat units having the structure

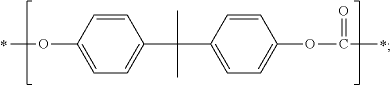

the block polyestercarbonate comprises 10 to 40 weight percent of the polyester block and 60 to 90 weight percent of the polycarbonate block; the brominated polycarbonate comprises repeat units having the structures

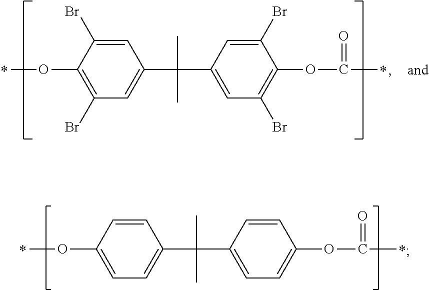

the black colorant comprises carbon black; the composition comprises 28 to 38 weight percent of the brominated polycarbonate, 10 to 25 weight percent of the poly(butylene terephthalate), 25 to 35 weight percent of the block polyestercarbonate, 4 to 8 weight percent of the diantimony trioxide, and 0.4 to 2 weight percent of the black colorant; and the composition further comprises 5 to 11 weight percent of a poly(butyl acrylate-co-methyl methacrylate).

The invention includes at least the following embodiments.

### Embodiment 1

A composition comprising, based on the total weight of the composition: 20 to 50 weight percent of a brominated polycarbonate; 10 to 50 weight percent of poly(butylene terephthalate); 10 to 40 weight percent of a block polyestercarbonate comprising a polyester block comprising resorcinol ester repeat units having the structure

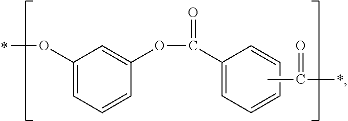

and
a polycarbonate block comprising carbonate repeat units having the structure

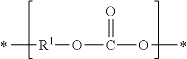

wherein at least 60 percent of the total number of R¹ groups are aromatic; 2 to 10 weight percent of diantimony trioxide; and 0.2 to 5 weight percent of a black colorant.

### Embodiment 2

The composition of embodiment 1, wherein the polyester block comprises resorcinol ester repeat units having the structures

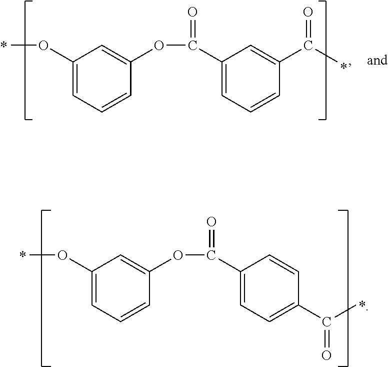

### Embodiment 3

The composition of embodiment 1 or 2, wherein the polycarbonate block comprises carbonate repeat units having the structure

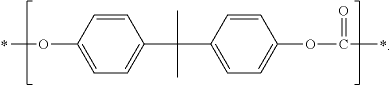

### Embodiment 4

The composition of any of embodiments 1-3, wherein the block polyestercarbonate further comprises resorcinol carbonate repeat units having the structure

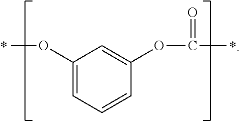

### Embodiment 5

The composition of any of embodiments 1-4, wherein the block polyestercarbonate comprises 10 to 40 weight percent of the polyester block and 60 to 90 weight percent of the polycarbonate block.

### Embodiment 6

The composition of any of embodiments 1-5, wherein the brominated polycarbonate comprises repeat units having the structures

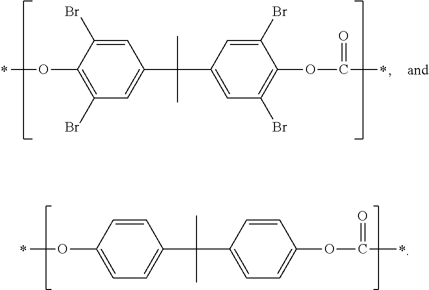

### Embodiment 7

The composition of any of embodiments 1-6, comprising 7 to 17 weight percent total bromine.

### Embodiment 8

The composition of any of embodiments 1-7, wherein the black colorant comprises carbon black, at least two dyes, or a combination thereof.

### Embodiment 9

The composition of any of claims 1-8, wherein the black colorant comprises at least two organic dyes.

### Embodiment 10

The composition of any of embodiments 1-9, further comprising 4 to 14 weight percent of an impact modifier selected from the group consisting of poly(butyl acrylate-co-methyl methacrylate), poly(acrylonitrile-co-butadiene-co-styrene), poly(methyl methacrylate-co-butadiene-co-styrene), poly(acrylonitrile-co-styrene-co-acrylate), polyolefin elastomer, polycarbonate-polysiloxane block copolymer, and combinations thereof.

### Embodiment 11

The composition of any of embodiments 1-9, further comprising 4 to 14 weight percent of an impact modifier comprising poly(butyl acrylate-co-methyl methacrylate).

### Embodiment 12

The composition of any of embodiments 1-11, further comprising 5 to 20 weight percent of an unbrominated polycarbonate.

### Embodiment 13

The composition of embodiment 1, wherein the polyester block comprises resorcinol ester repeat units having the structures

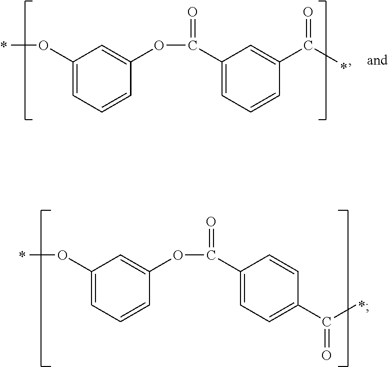

wherein the polycarbonate block comprises carbonate repeat units having the structure

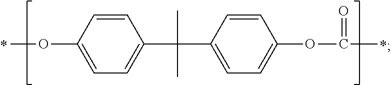

wherein the block polyestercarbonate comprises 10 to 40 weight percent of the polyester block and 60 to 90 weight percent of the polycarbonate block; wherein the brominated polycarbonate comprises repeat units having the structures

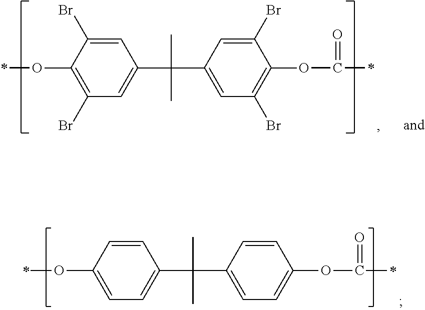

wherein the black colorant comprises carbon black; wherein the composition comprises 28 to 38 weight percent of the brominated polycarbonate, 10 to 25 weight percent of the poly(butylene terephthalate), 25 to 35 weight percent of the block polyestercarbonate, 4 to 8 weight percent of the diantimony trioxide, and 0.4 to 2 weight percent of the black colorant; and wherein the composition further comprises 5 to 11 weight percent of a poly(butyl acrylate-co-methyl methacrylate).

### Embodiment 14

An article comprising a composition comprising, based on the total weight of the composition: 20 to 50 weight percent of a brominated polycarbonate; 10 to 50 weight percent of poly(butylene terephthalate); 10 to 40 weight percent of a block polyestercarbonate comprising a polyester block comprising resorcinol ester repeat units having the structure

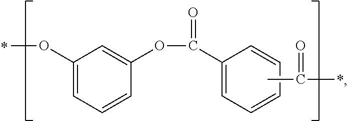

and
a polycarbonate block comprising carbonate repeat units having the structure

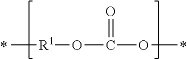

wherein at least 60 percent of the total number of R¹ groups are aromatic; 2 to 10 weight percent of diantimony trioxide; and 0.2 to 5 weight percent of a black colorant.

### Embodiment 15

The article of embodiment 14, wherein the article is a flat screen television bezel, a cell phone back, or an exterior part of a household appliance.

### Embodiment 16

The article of embodiment 14 or 15, wherein the polyester block comprises resorcinol ester repeat units having the structures

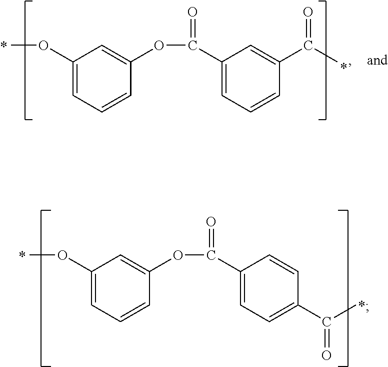

wherein the polycarbonate block comprises carbonate repeat units having the structure

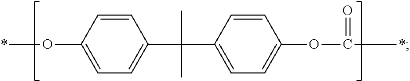

wherein the block polyestercarbonate comprises 10 to 40 weight percent of the polyester block and 60 to 90 weight percent of the polycarbonate block; wherein the brominated polycarbonate comprises repeat units having the structures

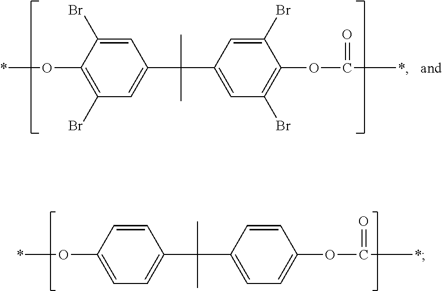

wherein the composition comprises 28 to 38 weight percent of the brominated polycarbonate, 10 to 25 weight percent of the poly(butylene terephthalate), 25 to 35 weight percent of the block polyestercarbonate, 4 to 8 weight percent of the diantimony trioxide, and 0.4 to 2 weight percent of the black colorant; and wherein the composition further comprises 5 to 11 weight percent of a poly(butyl acrylate-co-methyl methacrylate).

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### Examples 1-15, Comparative Examples 1-6

Components used to prepare thermoplastic compositions are summarized in Table 1.

TABLE 1

| Component | Description |
|---|---|
| PC1 | Bisphenol A polycarbonate, CAS Reg. No. 111211-39-3, having a weight |
| | average molecular weight of 29,900 atomic mass units; obtained from Sabic |
| | Innovative Plastic. |
| PC2 | Bisphenol A polycarbonate, CAS Reg. No. 111211-39-3, having a weight |
| | average molecular weight of 21,900 atomic mass units; obtained from Sabic |
| | Innovative Plastic. |
| PEC1 | A block polyestercarbonate, CAS Reg. No. 235420-85-6, comprising about |
| | 81 mole percent resorcinol iso-/terephthalate ester linkages, about 8 mole % |
| | resorcinol carbonate linkages, and about 11 mole % bisphenol A carbonate |
| | linkages, having a glass transition temperature of about 142° C.; obtained |
| | from Sabic Innovative Plastics. |
| PEC2 | A block polyestercarbonate, CAS Reg. No. 235420-85-6, comprising about |
| | 19 mole percent resorcinol iso-/tereplithalate ester linkages, about 6 mole % |
| | resorcinol carbonate linkages, and about 75 mole % bisphenol A carbonate |
| | linkages, having a glass transition temperature of about 136° C.; obtained |
| | from Sabic Innovative Plastics. |
| PBT | Poly (1,4-butylene terephthalate), CAS Reg. No. 26062-94-2, having an |
| | intrinsic viscosity of 1.1 deciliters/gram; obtained from Changchun Plastics. |
| p(BA/MMA) | Poly(butyl acrylate-co-methyl methacrylate), CAS Reg. No. 25852-37-3, |
| | containing 1-3 weight percent calcium carbonate, CAS Reg. No. 471-34-1; |
| | obtained as PARALOID ™ KM-330 Impact Modifier from The Dow |
| | Chemical Company. |
| PC-Br | A brominated polycarbonate that is a copolymer of phosgene, |
| | 4,4-(1-methylethylidene-bis(2,6-dibromophenol), and |
| | 4,4-(1-methylethylidiene)bisphenol, endcapped with the ester of |
| | p-cumylphenol, polymer CAS Reg. No. 156042-31-8, having a bromine |
| | content of about 26 weight percent, a weight average molecular weight of |
| | about 24,000 atomic mass units, and a glass transition temperature of about |
| | 185° C.; obtained from Sabic Innovative Plastics. |
| Sb₂O₃/EVA | A blend of 85 weight percent antimony trioxide, CAS Reg. No. 1309-64-4 |
| | and 15 poly(ethylene-co-vinyl acetate), CAS Reg. No. 24937-78-8; obtained |
| | from GuangXi Brightsun. |
| TSAN | Polytetrafluoroethylene, CAS 9002-84-0, 50 weight percent, encapsulated in |
| | poly(styrene-co-acrylonitrile), CAS 9003-54-7, 50 weight percent; obtained |
| | as CYCOLAC ™ Resin INTP449 from SABIC Innovative Plastics. |
| p(E/EA) | Poly(ethylene-co-ethyl acrylate), CAS Reg. No. 9010-86-0, having an ethyl |
| | acrylate content of about 12-21 weight percent weight percent; obtained from |
| | the Dow Chemical Company. |
| AO | The antioxidant pentaerythritol tetrakis(3,5-di-tert-butyl-4- |
| | hydroxyhydrocinnamate), CAS Reg. No. 6683-19-8; obtained as |
| | IRGANOX ™ 1010 from BASF. |
| Quencher | Monozinc phosphate (ZnH₂PO₄), CAS Reg. No. 13598-37-3; obtained as |
| | Z21-82 from Budenheim Iberica. |
| UVA | The ultraviolet light absorber 2-(2′-hydroxy-5-t-octylphenyl)-benzotriazole, |
| | CAS Reg. No. 3147-75-9; obtained as CYASORBT ™ UV 5411 from Cytec. |
| CB | Carbon black, CAS Reg. No. 1333-86-4; obtained as MONARCH ™ 800 |
| | from Cabot. |
| S. Green 3 | Solvent Green 3, CAS Reg. No. 128-80-3; obtained as MACROLEX ™ |
| | Green 5B from Lanxess. |
| S. Red. 135 | Solvent Red 135, CAS Reg. No. 20749-68-2; obtained as MACROLEX ™ |
| | Red EG from Lanxess. |

Each composition was prepared by dry-blending all components, then adding the dry-blended mixture to the feed throat of a twin-screw extruder having a screw diameter of 37 millimeters, a screw length of 1.5 meters, a screw rotation rate of 300 rotations per minute, a throughput of 60 kilograms per hour, 45% torque, and zone temperatures of 50° C./100° C./200° C./260° C./270° C./255° C./255° C./260° C./270° C./260° C./230° C. from feed throat to die.

The extrudate was pelletized, and the pellets dried for four hours at 120° C. Parts for property testing were molded in accordance with the respective ASTM standards in an injection molding machine operating at a hopper temperature of 70° C., barrel temperatures of 240° C./250° C./250° C./250° C., a mold temperature of 80° C., a screw speed of 100 rotations per minute, and a back pressure of 30 kilogram-force per centimeter².

Melt flow rate values, expressed in grams per 10 minutes, were determined according to ASTM D1238-13 at 265° C. and 5 kilogram load. Unnotched Izod impact strength values, expressed in joules/meter, were determined according to ASTM D4812-11 at 23° C. on samples having dimensions 63.5 millimeters×12.7 millimeters×3.2 millimeters. Notched Izod impact strength values, expressed in joules/meter, were determined according to ASTM D256-10 at 23° C. on samples having dimensions 63.5 millimeters×12.7 millimeters×3.2 millimeters. Tensile stress values at break, expressed in units of megapascals, were determined according to ASTM D638-10 at 23° C. using a tensile bar having a thickness of 3.2 millimeters, and a test speed of 50 millimeters per minute. Heat deflection temperature values, expressed in ° C., were determined according to ASTM D648-07 using bar cross-section dimensions of 3.2 millimeters×12.5 millimeters, an edgewise test direction, a support span of 100 millimeters (Method B), a loading fiber stress of 1.82 megapascals, a heating rate of 2.0° C. per minute, and a deflection at reading of 0.25 millimeter.

Flame retardancy of injection molded flame bars was determined according to Underwriter's Laboratory Bulletin 94 “Tests for Flammability of Plastic Materials, UL 94”, 20 mm Vertical Burning Flame Test. Before testing, flame bars with a thickness of 0.6 millimeters were conditioned at 23° C. and 50% relative humidity for at least 48 hours. In the UL 94 20 mm Vertical Burning Flame Test, a set of five flame bars was tested. For each bar, a flame was applied to the bar then removed, and the time required for the bar to self-extinguish (first afterflame time, t1) was noted. The flame was then reapplied and removed, and the time required for the bar to self-extinguish (second afterflame time, t2) and the post-flame glowing time (afterglow time, t3) were noted. To achieve a rating of V-0, the afterflame times t1 and t2 for each individual specimen must have been less than or equal to 10 seconds; and the total afterflame time for all five specimens (t1 plus t2 for all five specimens) must have been less than or equal to 50 seconds; and the second afterflame time plus the afterglow time for each individual specimen (t2+t3) must have been less than or equal to 30 seconds; and no specimen can have flamed or glowed up to the holding clamp; and the cotton indicator cannot have been ignited by flaming particles or drops. To achieve a rating of V-1, the afterflame times t1 and t2 for each individual specimen must have been less than or equal to 30 seconds; and the total afterflame time for all five specimens (0 plus t2 for all five specimens) must have been less than or equal to 250 seconds; and the second afterflame time plus the afterglow time for each individual specimen (t2+t3) must have been less than or equal to 60 seconds; and no specimen can have flamed or glowed up to the holding clamp; and the cotton indicator cannot have been ignited by flaming particles or drops. To achieve a rating of V-2, the afterflame times t1 and t2 for each individual specimen must have been less than or equal to 30 seconds; and the total afterflame time for all five specimens (0 plus t2 for all five specimens) must have been less than or equal to 250 seconds; and the second afterflame time plus the afterglow time for each individual specimen (t2+t3) must have been less than or equal to 60 seconds; and no specimen can have flamed or glowed up to the holding clamp; but the cotton indicator can have been ignited by flaming particles or drops. Compositions not achieving a rating of V-2 were considered to have failed.

CIE1976 LAB color data and reflection curves were acquired on an X-Rite ColorEye 7000A with D65 illumination, 10° observer, UV included, and reflection mode. SCI and SCE modes were used to include and exclude, respectively, specular reflected light and give results that were respectively dependent on and independent of surface gloss.

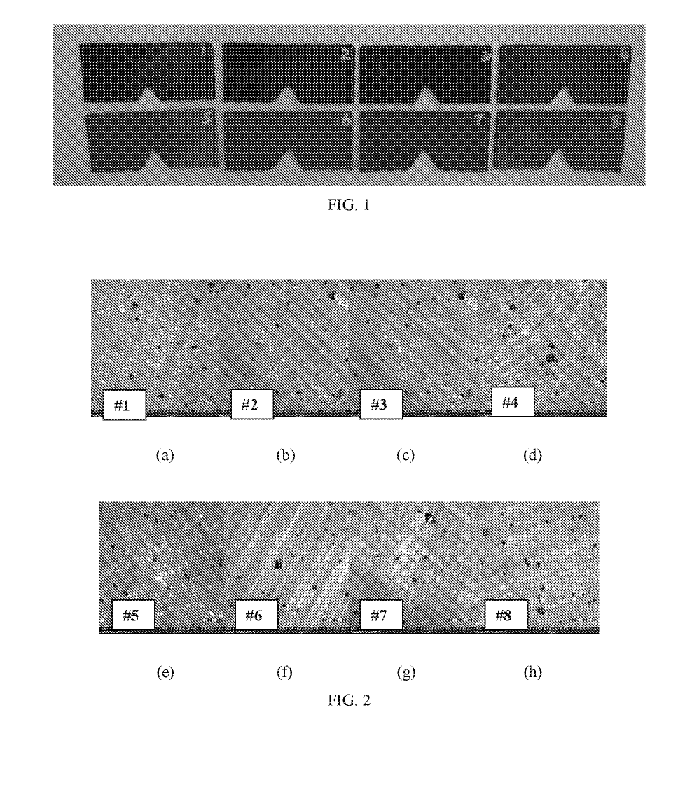

Table 2 summarizes compositions and properties for examples varying in polycarbonate content, poly(butyl acrylate-co-methyl methacrylate) content, block polyestercarbonate type and amount, and colorant type and amount. In Table 2, component amounts are expressed in weight percent based on the total weight of the composition. Comparative Examples 1 and 2, and Examples 1 and 2 all contain carbon black as black colorant. Relative to Comparative Example 1 (with impact modifier but no block polyestercarbonate), Comparative Example 2 (without impact modifier or block polyestercarbonate) and Example 1 (without impact modifier and with block polyestercarbonate) exhibited desirably lower values of L* in both SCI and SCE modes. The deeper black of Comparative Example 2 and Example 1 was also evident from visual inspection, as shown in FIG. 1, where sample numbers 1-8 correspond, respectively, to Comparative Examples 1 and 2, Examples 1 and 2, Comparative Examples 3 and 4, and Examples 3 and 4. Example 2 is representative of a composition useful for applications requiring high ductility. It exhibits higher notched Izod impact strength and tensile stress than Comparative Example 1, while also exhibiting desirably lower L* values in both SCI and SCE modes. Similar trends are observed for Comparative Examples 3 and 4, and Examples 3 and 4, all containing a dye combination as the black colorant.

Higher L* values in SCE mode can be explained by the contribution of surface reflection to SCE L*. Surface reflection is determined by the distribution of polymer blocks and internal scattering. While not wishing to be bound by any particular theory of operation, Applicants believe that the SEM images in FIG. 2 are consistent with the block polyestercarbonate acting as a compatibilizer for polycarbonate and poly(butylene terephthalate), which minimizes the internal scattering of the base resin. As a result, the block polyestercarbonate-containing compositions exhibited surfaces with better color manifested as a lower SCE mode L* value for Example 1 versus Comparative Example 1. There is no evidence in either the SCE data or the SEM images for a large difference in internal scattering between Comparative Example 2 and Example 1. All samples exhibited that same unnotched Izod value of 2150 joules/meter because none of the samples broke. Although Comparative Example 2 exhibited a low L* value in SCE mode, it also exhibited a low notched Izod impact strength value.

TABLE 2

| | | | |
|---|---|---|---|
| C. Ex. 1 | C. Ex. 2 | Ex. 1 | Ex. 2 |

COMPOSITIONS

| | | | | |
|---|---|---|---|---|
| Antioxidant | 0.06 | 0.06 | 0.06 | 0.06 |
| Sb₂O₃/EVA | 6.27 | 6.27 | 6.27 | 6.27 |
| UVA | 0.25 | 0.25 | 0.25 | 0.25 |
| p(E/EA) | 2.59 | 2.59 | 2.59 | 2.59 |
| TSAN | 0.20 | 0.20 | 0.20 | 0.20 |
| Quencher | 0.20 | 0.20 | 0.20 | 0.20 |
| PC-Br | 32.84 | 32.84 | 32.84 | 32.84 |
| PC1 | 14.93 | 25.27 | 5.37 | 7.35 |
| p(BA/MMA) | 10.35 | 0.00 | 0.00 | 7.46 |
| PBT | 31.83 | 31.83 | 31.83 | 22.39 |
| PEC2 | 0.00 | 0.00 | 19.90 | 19.90 |
| CB | 0.50 | 0.50 | 0.50 | 0.50 |
| S. Green 3 | 0.00 | 0.00 | 0.00 | 0.00 |
| S. Red 135 | 0.00 | 0.00 | 0.00 | 0.00 |

PHYSICAL PROPERTIES

| | | | | |
|---|---|---|---|---|
| Notched Izod (J/m) | 582 | 102 | 90.6 | 617 |
| Unnotched Izod (J/m) | 2150 | 2150 | 2150 | 2150 |
| Tensile stress (MPa) | 2182.8 | 2494.2 | 2502.8 | 2216.8 |
| HDT (° C.) | 119 | 124 | 109 | 112 |

Color, SCI Mode

| | | | | |
|---|---|---|---|---|
| L* | 31.4 | 30.0 | 30.3 | 31.0 |
| a* | −0.2 | −0.1 | −0.2 | −0.2 |
| b* | −1.5 | −2.0 | −2.1 | −1.6 |

Color, SCE Mode

| L* | 22.1 | 10.8 | 12.3 | 17.9 |
|---|---|---|---|---|
| a* | −0.6 | −0.3 | −0.3 | −0.6 |
| b* | −3.1 | −3.1 | −3.4 | −2.7 |
| | C. Ex. 3 | C. Ex. 4 | Ex. 3 | Ex. 4 |

COMPOSITIONS

| | | | | |
|---|---|---|---|---|
| Antioxidant | 0.06 | 0.06 | 0.06 | 0.06 |
| Sb₂O₃/EVA | 6.27 | 6.27 | 6.27 | 6.27 |
| UVA | 0.25 | 0.25 | 0.25 | 0.25 |
| p(E/EA) | 2.59 | 2.59 | 2.59 | 2.59 |
| TSAN | 0.20 | 0.20 | 0.20 | 0.20 |
| Quencher | 0.20 | 0.20 | 0.20 | 0.20 |
| PC-Br | 32.84 | 32.84 | 32.84 | 32.84 |
| PC1 | 14.93 | 25.27 | 5.37 | 7.35 |
| p(BA/MMA) | 10.35 | 0.00 | 0.00 | 7.46 |
| PBT | 31.83 | 31.83 | 31.83 | 22.39 |
| PEC2 | 0.00 | 0.00 | 19.90 | 19.90 |
| CB | 0.00 | 0.00 | 0.00 | 0.00 |
| S. Green 3 | 0.25 | 0.25 | 0.25 | 0.25 |
| S. Red 135 | 0.25 | 0.25 | 0.25 | 0.25 |

PHYSICAL PROPERTIES

| | | | | |
|---|---|---|---|---|
| Notched Izod (J/m) | 592 | 114 | 85 | 669 |
| Unnotched Izod (J/m) | 2150 | 2150 | 2150 | 2150 |
| Tensile stress (MPa) | 2132.6 | 2473.4 | 2502.6 | 2205.2 |
| HDT (° C.) | 115 | 124 | 107 | 105 |

Color, SCI Mode

| | | | | |
|---|---|---|---|---|
| L* | 38.1 | 34.2 | 34.2 | 36.8 |
| a* | −1.4 | −0.8 | −0.9 | −1.4 |
| b* | −6.4 | −6 | −5.9 | −6.6 |

Color, SCE Mode

| | | | | |
|---|---|---|---|---|
| L* | 31.8 | 20.8 | 21.0 | 26.9 |
| a* | −2.1 | −1.6 | −1.6 | −1.9 |
| b* | −8.5 | −9.2 | −8.9 | −9.1 |

In order to further study the compatibilizing effect of polyestercarbonate in a polycarbonate/poly(butylene terephthalate) matrix, another set of examples was prepared with varying ratios of polycarbonate, poly(butylene terephthalate), and polyestercarbonate. Two different polyestercarbonates were employed, PEC1 with about 81 mole percent resorcinol ester linkages, about 8 mole % resorcinol carbonate linkages, and about 11 mole % bisphenol A carbonate linkages, and PEC2 with about 19 mole percent resorcinol ester linkages, about 6 mole % resorcinol carbonate linkages, and about 75 mole % bisphenol. A carbonate linkages. Polyestercarbonate content was maintained at 30.64 weight percent in all examples. Comparative Example 5 was a control example lacking polyestercarbonate. Examples 5-9 represent variations in the ratio of poly(butylene terephthalate) to polyestercarbonate from 1:3 to 1:1. Examples 11 and 12 provide a balance of desired color and improved ductility. Examples 10 and 16 utilize PEC1 rather than PEC2.

Among the carbon black-containing samples, Examples 5-12 containing polyester carbonate exhibited desirably lower L* values in SCI and SCE modes relative to Comparative Example 5 without polyestercarbonate. All the samples without impact modifier (Examples 5-10, 14, and 16) have lower L* values than the samples with impact modifier (Comparative Example 1, Examples 11-13 and 15). L* values for Examples 5-9 suggest that L* undesirably increases slightly as the ratio of poly(butylene terephthalate) to polyestercarbonate increases from 1:3 to 1:1.

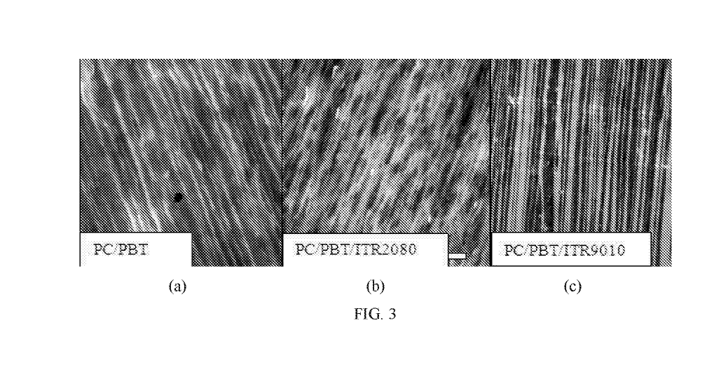

A comparison of Examples 7 and 10 indicates that the polyestercarbonate PEC1, with a relatively high content of polyester linkages, is not as effective a compatibilizer as PEC2 with a lower content of polyester linkages. This is also apparent in the SEM images of FIG. 3, where “ITR2080” in FIG. 3(b) refers to PEC2, and “ITR9010” in FIG. 3(c) refers to PEC1. Example 7, with PEC2, also exhibits better ductility than Example 10, with PEC1.

All samples exhibited excellent flame retardancy, manifested as a UL 94 V-0 rating at a thickness of 0.6 millimeters.

TABLE 3

| | | | | |
|---|---|---|---|---|
| C. Ex. 5 | Ex. 5 | Ex. 6 | Ex. 7 | Ex. 8 |

COMPOSITIONS

| | | | | | |
|---|---|---|---|---|---|
| PC1 | 15.32 | 17.76 | 12.66 | 7.55 | 2.44 |
| PBT | 32.68 | 10.21 | 15.32 | 20.43 | 25.54 |
| p(BA/MMA) | 10.62 | 0.00 | 0.00 | 0.00 | 0.00 |
| PEC2 | 0.00 | 30.64 | 30.64 | 30.64 | 30.64 |
| PEC1 | 0.00 | 0.00 | 0.00 | 0.00 | 0.00 |
| PC-Br | 33.71 | 33.71 | 33.71 | 33.71 | 33.71 |
| Sb₂O₃/EVA | 6.44 | 6.44 | 6.44 | 6.44 | 6.44 |
| Quencher | 0.20 | 0.20 | 0.20 | 0.20 | 0.20 |
| UVA | 0.26 | 0.26 | 0.26 | 0.26 | 0.26 |
| TSAN | 0.20 | 0.20 | 0.20 | 0.20 | 0.20 |
| AO | 0.06 | 0.06 | 0.06 | 0.06 | 0.06 |
| CB | 0.51 | 0.51 | 0.51 | 0.51 | 0.51 |
| S. Green 3 | 0.00 | 0.00 | 0.00 | 0.00 | 0.00 |
| S. Red 135 | 0.00 | 0.00 | 0.00 | 0.00 | 0.00 |

PHYSICAL PROPERTIES

| | | | | | |
|---|---|---|---|---|---|
| MFR (g/10 min) | 6.30 | 6.48 | 7.37 | 10.80 | 9.06 |
| Notched Izod (J/m) | 521.0 | 114.0 | 97.7 | 97.3 | 77.4 |
| Unnotched Izod (J/m) | 1670.0 | 1710.0 | 1710.0 | 1710.0 | 1690.0 |
| Tensile Stress (MPa) | 2042.2 | 2455.6 | 2464.6 | 2454.0 | 2439.0 |
| UL 94 Rating | V-0 | V-0 | V-0 | V-0 | V-0 |

Color, SCI Mode

| | | | | | |
|---|---|---|---|---|---|
| L* | 32.9 | 29.7 | 29.7 | 29.7 | 29.8 |
| a* | 0.0 | −0.2 | −0.2 | −0.2 | −0.2 |
| b* | 0.6 | −1.5 | −1.5 | −1.5 | −1.4 |

Color, SCE Mode

| L* | 18.9 | 10.2 | 10.6 | 10.7 | 11.4 |
|---|---|---|---|---|---|
| a* | 0.3 | −0.3 | −0.3 | −0.3 | −0.3 |
| b* | 1.7 | −3.0 | −3.0 | −2.7 | −2.7 |
| | Ex. 9 | Ex. 10 | Ex. 11 | Ex. 12 | C. Ex. 6 |

COMPOSITIONS

| | | | | | |
|---|---|---|---|---|---|
| PC1 | 0.00 | 7.55 | 5.11 | 0.00 | 15.24 |
| PBT | 30.64 | 20.43 | 15.32 | 20.43 | 32.51 |
| p(BA/MMA) | 0.00 | 0.00 | 7.55 | 7.55 | 10.57 |
| PEC2 | 30.64 | 0.00 | 30.64 | 30.64 | 0.00 |
| PEC1 | 0.00 | 30.64 | 0.00 | 0.00 | 0.00 |
| PC-Br | 31.04 | 33.71 | 33.71 | 33.71 | 33.54 |
| Sb₂O₃/EVA | 6.44 | 6.44 | 6.44 | 6.44 | 6.40 |
| Quencher | 0.20 | 0.20 | 0.20 | 0.20 | 0.20 |
| UVA | 0.26 | 0.26 | 0.26 | 0.26 | 0.25 |
| TSAN | 0.20 | 0.20 | 0.20 | 0.20 | 0.20 |
| AO | 0.06 | 0.06 | 0.06 | 0.06 | 0.06 |
| CB | 0.51 | 0.51 | 0.51 | 0.51 | 0.00 |
| S. Green 3 | 0.00 | 0.00 | 0.00 | 0.00 | 0.51 |
| S. Red 135 | 0.00 | 0.00 | 0.00 | 0.00 | 0.51 |

PHYSICAL PROPERTIES

| | | | | | |
|---|---|---|---|---|---|
| MFR (g/10 min) | 10.9 | 9.02 | 6.53 | 7.10 | 7.59 |
| Notched Izod (J/m) | 81.6 | 62.2 | 643.0 | 652.0 | 542.0 |
| Unnotched Izod (J/m) | 1710.0 | 1390.0 | 1690.0 | 1670.0 | 1450.0 |
| Tensile Stress (MPa) | 2451.4 | 2399.6 | 2177.2 | 2154.0 | 2050.4 |
| UL 94 Rating | V-0 | V-0 | V-0 | V-0 | V-0 |

Color, SCI Mode

| | | | | | |
|---|---|---|---|---|---|
| L* | 29.7 | 29.8 | 32.7 | 32.6 | 35.8 |
| a* | −0.2 | −0.2 | −0.4 | −0.3 | −1.2 |
| b* | −1.4 | −1.6 | −0.5 | −0.4 | −2.4 |

Color, SCE Mode

| | | | | | |
|---|---|---|---|---|---|
| L* | 12.3 | 11.3 | 18.3 | 18.3 | 24.5 |
| a* | −0.3 | −0.3 | −0.5 | −0.5 | −1.8 |
| b* | −2.8 | −3.0 | −0.4 | 0.0 | −3.5 |

| | | |
|---|---|---|
| Ex. 13 | Ex. 14 | Ex. 15 |

COMPOSITIONS

| | | | |
|---|---|---|---|
| PC1 | 7.55 | 0.00 | 7.55 |
| PBT | 20.43 | 20.43 | 20.43 |
| p(BA/MMA) | 0.00 | 7.55 | 0.00 |
| PEC2 | 30.64 | 30.64 | 0.00 |
| PEC1 | 0.00 | 0.00 | 30.64 |
| PC-Br | 33.71 | 33.71 | 33.71 |
| Sb₂O₃/EVA | 6.44 | 6.44 | 6.44 |
| Quencher | 0.20 | 0.20 | 0.20 |
| UVA | 0.26 | 0.26 | 0.26 |
| TSAN | 0.20 | 0.20 | 0.20 |
| AO | 0.06 | 0.06 | 0.06 |
| CB | 0.00 | 0.00 | 0.00 |
| S. Green 3 | 0.51 | 0.51 | 0.51 |
| S. Red 135 | 0.51 | 0.51 | 0.51 |

PHYSICAL PROPERTIES

| | | | |
|---|---|---|---|
| MFR (g/10 min) | 10.1 | 8.35 | 9.69 |
| Notched Izod (J/m) | 102.0 | 651.0 | 81.6 |
| Unnotched Izod (J/m) | 1710.0 | 1680.0 | 1710.0 |
| Tensile Stress (MPa) | 2441.8 | 2222.6 | 2346.8 |
| UL 94 Rating | V-0 | V-0 | V-0 |

Color, SCI Mode

| | | | |
|---|---|---|---|
| L* | 30.5 | 34.8 | 30.9 |
| a* | −0.6 | −1.2 | −0.4 |
| b* | −3.7 | −3.1 | −3.9 |

Color, SCE Mode

| | | | |
|---|---|---|---|
| L* | 13.7 | 22.8 | 15.2 |
| a* | −1.2 | −2.0 | −0.8 |
| b* | −7.2 | −4.7 | −7.2 |

1. A composition comprising, based on the total weight of the composition:
20 to 50 weight percent of a brominated polycarbonate;
10 to 50 weight percent of poly(butylene terephthalate);
10 to 40 weight percent of a block polyestercarbonate comprising
a polyester block comprising resorcinol ester repeat units having the structure 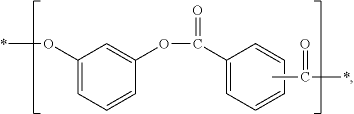
and
a polycarbonate block comprising carbonate repeat units having the structure 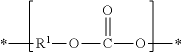
wherein at least 60 percent of the total number of R¹ groups are aromatic;
2 to 10 weight percent of diantimony trioxide; and
0.2 to 5 weight percent of a black colorant.

2. The composition of claim 1, wherein the polyester block comprises resorcinol ester repeat units having the structures

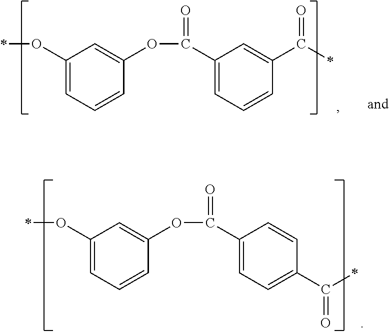

3. The composition of claim 1, wherein the polycarbonate block comprises carbonate repeat units having the structure

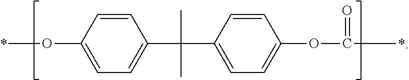

4. The composition of claim 1, wherein the block polyestercarbonate further comprises resorcinol carbonate repeat units having the structure

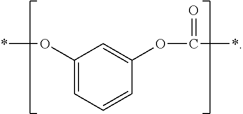

5. The composition of claim 1, wherein the block polyestercarbonate comprises 10 to 40 weight percent of the polyester block and 60 to 90 weight percent of the polycarbonate block.

6. The composition of claim 1, wherein the brominated polycarbonate comprises repeat units having the structures

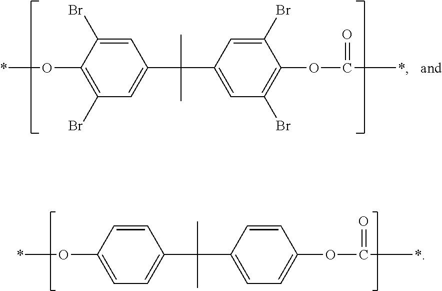

7. The composition of claim 1, comprising 7 to 17 weight percent total bromine.

8. The composition of claim 1, wherein the black colorant comprises carbon black, at least two dyes, or a combination thereof.

9. The composition of claim 1, wherein the black colorant comprises at least two organic dyes.

10. The composition of claim 1, further comprising 4 to 14 weight percent of an impact modifier selected from the group consisting of poly(butyl acrylate-co-methyl methacrylate), poly(acrylonitrile-co-butadiene-co-styrene), poly(methyl methacrylate-co-butadiene-co-styrene), poly(acrylonitrile-co-styrene-co-acrylate), polyolefin elastomer, polycarbonate-polysiloxane block copolymer, and combinations thereof.

11. The composition of claim 1, further comprising 4 to 14 weight percent of an impact modifier comprising poly(butyl acrylate-co-methyl methacrylate).

12. The composition of claim 1, further comprising 5 to 20 weight percent of an unbrominated polycarbonate.

13. The composition of claim 1,
wherein the polyester block comprises resorcinol ester repeat units having the structures 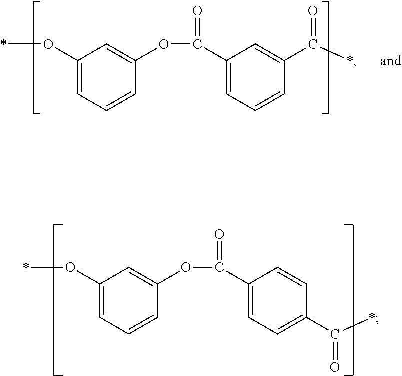
wherein the polycarbonate block comprises carbonate repeat units having the structure 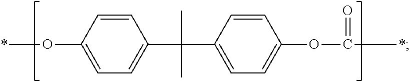
wherein the block polyestercarbonate comprises 10 to 40 weight percent of the polyester block and 60 to 90 weight percent of the polycarbonate block;
wherein the brominated polycarbonate comprises repeat units having the structures 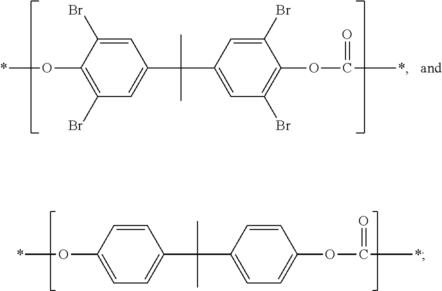
wherein the black colorant comprises carbon black;
wherein the composition comprises
28 to 38 weight percent of the brominated polycarbonate,
10 to 25 weight percent of the poly(butylene terephthalate),
25 to 35 weight percent of the block polyestercarbonate,
4 to 8 weight percent of the diantimony trioxide, and
0.4 to 2 weight percent of the black colorant; and
wherein the composition further comprises 5 to 11 weight percent of a poly(butyl acrylate-co-methyl methacrylate).

14. An article comprising a composition comprising, based on the total weight of the composition:
20 to 50 weight percent of a brominated polycarbonate;
10 to 50 weight percent of poly(butylene terephthalate);
10 to 40 weight percent of a block polyestercarbonate comprising
a polyester block comprising resorcinol ester repeat units having the structure 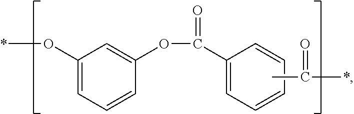
and
a polycarbonate block comprising carbonate repeat units having the structure 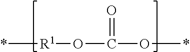
wherein at least 60 percent of the total number of R¹ groups are aromatic;
2 to 10 weight percent of diantimony trioxide; and
0.2 to 5 weight percent of a black colorant.

15. The article of claim 14, wherein the article is a flat screen television bezel, a cell phone back, or an exterior part of a household appliance.

16. The article of claim 14,
wherein the polyester block comprises resorcinol ester repeat units having the structures 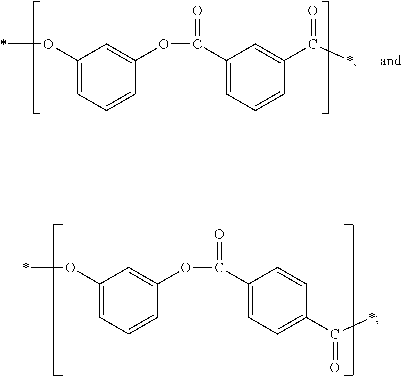
wherein the polycarbonate block comprises carbonate repeat units having the structure 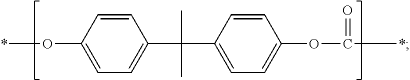
wherein the block polyestercarbonate comprises 10 to 40 weight percent of the polyester block and 60 to 90 weight percent of the polycarbonate block;
wherein the brominated polycarbonate comprises repeat units having the structures 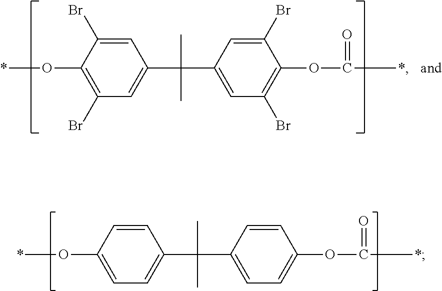
wherein the composition comprises
28 to 38 weight percent of the brominated polycarbonate,
10 to 25 weight percent of the poly(butylene terephthalate),
25 to 35 weight percent of the block polyestercarbonate,
4 to 8 weight percent of the diantimony trioxide, and
0.4 to 2 weight percent of the black colorant; and
wherein the composition further comprises 5 to 11 weight percent of a poly(butyl acrylate-co-methyl methacrylate).
